(19) United States
(12) Patent Application Publication
(10) Pub. No.: US 2026/0238737 A1
(43) Pub. Date: Aug. 13, 2026

(54) NATURAL LANGUAGE VIDEO/AUDIO EFFECT PLUGIN GENERATION

(71) Applicant: Ross Video Limited, Iroquois (CA)

(72) Inventor: Troy English, Ottawa (CA)

(21) Appl. No.: 19/049,335

(22) Filed: Feb. 10, 2025

(51) Int. Cl. H04N 5/262

(52) U.S. Cl. CPC H04N 5/262

(57) ABSTRACT

The present disclosure relates to video/audio effect plugin generation based on a natural language description of the effect. Natural language input describing an effect to be applied during processing of a signal by processing equipment is received from a user. The effect may be a video effect, an audio effect, or a combined video and audio effect, and the signal may be a video signal, an audio signal, or a combined video and audio signal. An effect plugin that is compatible with the processing equipment for the processing equipment to apply the effect during the processing of the signal is automatically generated based on the natural language input.

### FIELD

The present disclosure relates generally to video/audio processing equipment for processing video and/or audio, and in particular to generation of effect plugins for effects, that are to be applied during video/audio processing, from natural language user input.

### BACKGROUND

Users of video/audio processing equipment are not able to specify a kind of desired effect that is not already supported by such processing equipment, and have it operational in that processing equipment. Implementing a new effect in such equipment requires creators of the equipment to write code to implement the effect, or to allow other developers to write modules that run on such equipment.

Computer programming can be a complex task, especially for those who might use particular types of electronic equipment but are not intimately familiar with effective programming practices. For example, a user of a video/audio production system might wish to create effects that are not currently supported, but might not be well versed in computer programming.

Although existing Artificial Intelligence (AI) systems, for example, may be able to create algorithms or images, nothing allows them to create an effect that is run within video/audio processing equipment, either in realtime for live production for example, or non-realtime for editing for example.

There remains a need to better support user creation of effect plugins for video and/or audio processing.

### SUMMARY

Embodiments disclosed herein may allow a user of video/audio processing equipment to describe, using natural language, a kind of effect that they wish to implement, and then have an effect plugin for that effect generated and be available for use with the equipment.

One aspect of the present disclosure relates to an apparatus, which may be integrated with processing equipment or separate from video/audio processing equipment. Such an apparatus may include an input interface and an effect plugin generator. The input interface is to receive, from a user, natural language input describing an effect that is to be applied during processing of a signal by processing equipment. The effect may be a video effect, an audio effect, or a combined video and audio effect. The signal that is processed by the processing equipment may be or include a video signal, an audio signal, or a combined video and audio signal. The effect plugin generator is coupled to the input interface, to generate an effect plugin based on the natural language input received from the user. The effect plugin is compatible with the processing equipment, for the processing equipment to apply the effect during the processing of the signal.

Another aspect of the present disclosure relates to a method that involves: receiving, from a user, natural language input describing an effect that is to be applied during processing of a signal by processing equipment. As in other embodiments, the effect may be a video effect, an audio effect, or a combined video and audio effect, and the signal may be or include a video signal, an audio signal, or a combined video and audio signal. Such a method may also involve generating, based on the natural language input received from the user, an effect plugin that is compatible with the processing equipment for the processing equipment to apply the effect during the processing of the signal.

A non-transitory processor-readable medium is also disclosed, and stores instructions which, when executed by a processor, cause the processor to receive, from a user, natural language input describing an effect, and to generate, based on the natural language input received from the user, an effect plugin that is compatible with the processing equipment for the processing equipment to apply the effect during the processing of the signal. The effect may be a video effect, an audio effect, or a combined video and audio effect, and the signal may be or include a video signal, an audio signal, or a combined video and audio signal.

Other aspects and features of embodiments may become apparent to those ordinarily skilled in the art upon review of the following description.

### BRIEF DESCRIPTION OF THE DRAWINGS

Example embodiments will now be described in greater detail with reference to the accompanying drawings.

FIG. 1 illustrates an example of an apparatus and video/audio processing equipment.

FIG. 2 illustrates an example user interface.

FIG. 3 illustrates an example effect generator.

FIG. 4 illustrates an example process flow.

FIG. 5 illustrates a method according to an embodiment.

### DETAILED DESCRIPTION

Natural language video/audio effect generation as disclosed herein refers to generation of a plugin to provide an effect that is to be applied during processing of video and/or audio (that is, processing of a video signal, an audio signal, or a combined video and audio signal in which audio is integrated with video). Video/audio processing equipment may be capable of processing any of these types of signals, including multiple types of signals. A signal that is processed by video/audio processing equipment may include other content as well, such as metadata for example. References to signals and processing equipment herein should be interpreted accordingly.

Embodiments disclosed herein may be useful, for example, to enable a user who is less skilled or less experienced in generating program code and/or understanding how computer program code operates, to provide an effect.

Programming languages can be quite complex and difficult to use or understand, especially when a user is not a skilled programmer. Without effect plugin generation as disclosed herein, less skilled users would otherwise have to write, or engage others to write, program code to implement a desired effect.

Issues associated with having to write program code are inextricably rooted in computer technology, and specifically arise in the context of computing systems that implement video/audio processing. Such issues also represent challenges that are unique to computer technology.

For illustrative purposes, specific example embodiments will now be explained in greater detail below in conjunction with the figures.

The embodiments set forth herein represent information sufficient to practice the claimed subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

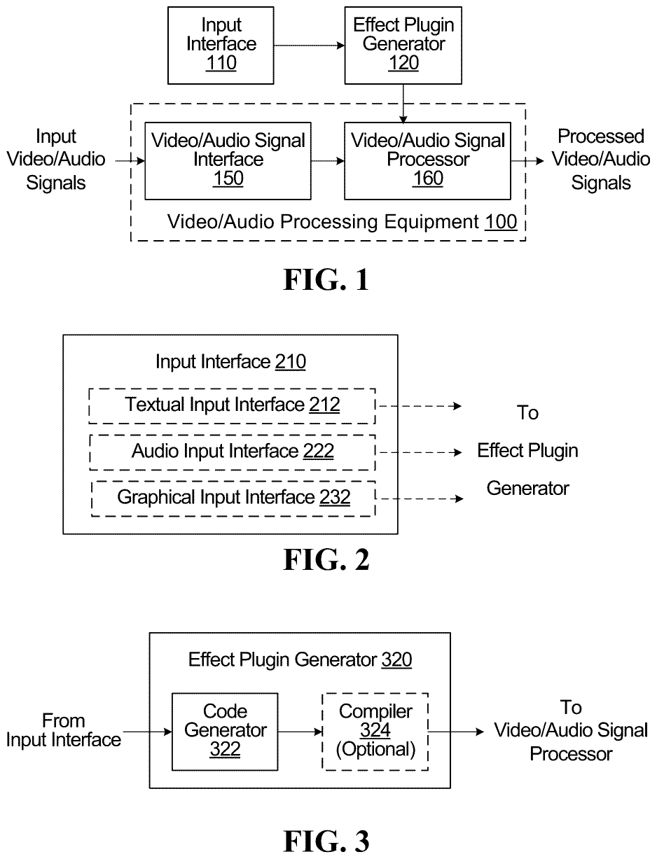

FIG. 1 illustrates an example of an apparatus and video/audio processing equipment 100. The apparatus includes an input interface 110 and an effect plugin generator 120, and the video/audio processing equipment 100 includes a video/audio signal interface 150 and a video/audio signal processor 160. These components are coupled together as shown. The example system 100 shown in FIG. 1, and similarly the contents of the other drawings, are intended solely for illustrative purposes. The present disclosure is in no way limited to the particular example embodiments explicitly shown in the drawings.

For example, in FIG. 1 the input interface 110 and the effect plugin generator 120 are illustrated separately from the video/audio processing equipment 100, and the effect plugin generator is coupled to the processing equipment. In other embodiments, effect plugin generation may be more closely integrated with video/audio processing equipment, in which case a system may include an apparatus as shown at 110, 120, and video/audio processing equipment as shown at 100. Different degrees of integration are possible, including integration of such an apparatus into video/audio processing equipment, in which case video/audio processing equipment may include the components 110, 120, 150, 160 in FIG. 1.

Integrated effect plugin generation may provide particular benefits, such as a more consolidated or cohesive user interface. For example, the input interface 110 in a fully integrated solution in which effect plugin generation is integrated into video/audio processing equipment may be a user interface of the video/audio processing equipment that a user is already familiar with. Deployment of an effect plugin may also or instead be streamlined in a fully integrated embodiment, in that an effect plugin may be generated and deployed automatically within video/audio processing equipment, responsive to receiving natural language input from a user.

Another potential benefit of integrated embodiments relates to change management. With an integrated solution, for example, a plugin generator may be updated along with other processing equipment components, so that the effect plugin generator is adapted to any changes to the processing equipment and remains operable to generate effect plugins that are compatible with the processing equipment.

In general, hardware, firmware, components which execute software, or some combination thereof may be used in implementing any one or more (or all) of the illustrated components. Electronic devices that might be suitable for implementing these components include, among others, microprocessors, microcontrollers, Programmable Logic Devices (PLDs), Field Programmable Gate Arrays (FPGAs), Application Specific Integrated Circuits (ASICs), graphic processing units (GPUs) and other types of “intelligent” integrated circuits. For example, at least the video/audio signal processor 160 in FIG. 1 may be implemented in a GPU, and the effect plugin generator 120 may be implemented in the same processing unit or a different processing unit. Either or both of such processing units, or more generally an electronic device that implements any component, may be configured for operation by executing computer-executable or processor-executable software stored in a non-transitory computer or processor-readable memory.

Such a memory may be implemented using one or more memory devices, which could include a solid-state memory device and/or a memory device with a movable or even removable storage medium. Multiple different types of memory devices could be used to implement such a memory. In an embodiment, a memory stores software for execution by one or more processors and/or other electronic devices, or more generally software for configuring either or both of the effect plugin generator 120 or video/audio signal processor 160 for operation. A memory could also or instead store other content, such as plugins that provide or support user-generated effects as disclosed herein.

An input interface 110 and/or a video/audio signal interface 150 may also or instead be implemented, at least in part, with one or more electronic devices that are configured for operation by executing software. At least these components also include physical devices or components that enable inputs to be received. These inputs are user inputs in the case of the input interface 110, or video/audio signals in the case of the video/audio signal interface 150. Examples of user interfaces and associated devices that may be provided as an input interface 110 are provided at least below, and examples of video/audio signal interface devices include ports or connectors, for video and/or audio cables or other types of connections via which video/audio signals may be received for processing.

In operation, the input interface 110 is implemented to receive, from a user such as a user of the processing equipment 100, natural language input describing an effect that is to be applied during processing of a signal by the processing equipment. The effect described in natural language input may be or include any one or more of a video effect (that may be applied during processing of a video signal or a combined video and audio signal for example), an audio effect (that may be applied during processing of a video signal or a combined video and audio signal for example), or a combined video and audio effect (that may be applied during processing of a combined video and audio signal for example). Thus, an effect may be or include a video effect, an audio effect, or a combined video and audio effect, and a signal that is to be processed may be or include a video signal, an audio signal, or a combined video and audio signal.

An effect that is applied during processing of a signal may, but need not necessarily, be applied to the processing or to a signal that is being processed. For example, in some embodiments an effect may impact processing of a signal, and in this sense the effect may be applied to the processing or to the signal such that processing of the signal is changed by the effect. However, an effect may be related to processing of a signal and may be applied during processing of the signal by processing equipment without impacting that processing. As an example, an effect may provide a progress indicator to indicate how processing of a signal is progressing. Such an effect is related to processing of a signal and is applied during processing of the signal, but does not change how the signal is processed.

The effect generator 120 is coupled to the input interface 110 in the example shown, and is implemented to generate an effect plugin to apply the effect that is described by the natural language input received from the user via the input interface.

Any of various types of user input may be supported. FIG. 2 illustrates an example input interface 210, which may be implemented as the input interface 110 in FIG. 1. In the example shown in FIG. 2, user interface components include a textual input interface 212, an audio input interface 222, and a graphical input interface 232. These interface components 212, 222, 232 are shown in dashed lines to indicate that an input interface may include any one or more of these user interface types.

In some embodiments, the input interface 210 provides a textual input interface 212 to receive textual input that includes a natural language input describing an effect. For example, a keyboard could be implemented to allow a user to enter text to describe an effect that the user wishes to newly implement in processing equipment.

A microphone is an example of an audio input interface 222 that may also or instead be provided by an input interface, to receive speech input. Such speech input is another example of natural language input that may be received from a user to describe an effect that the user wishes to implement in processing equipment.

An input interface may also or instead provide a graphical user interface (GUI) to receive graphical input, which is another example of natural language input that may be received from a user. For example, a mouse could be implemented to allow the user to select or otherwise graphically manipulate graphical elements that include or represent natural language or parts thereof, to describe a desired effect. In some embodiments, a display might also support user input, as in the case of a touchscreen display, for example.

With reference again to FIG. 1, the video/audio signal processor 160 is an example of a processor that is coupled to the effect plugin generator 120, and is to process a video/audio signal (which may be or include a video signal, an audio signal, or a combined video and audio signal). In an embodiment, the effect plugin generator 120 is configured to generate and provide, to the processor 160, an effect plugin that is compatible with the processing equipment 100 for the processing equipment to apply the effect during processing of a signal.

As used herein, “effect plugin” is intended to generally refer to a package that is generated (which may also be referred to as created) based on natural language input and is compatible with video/audio processing equipment such that the processing equipment may apply an effect that is described by the natural language input. Another example of compatibility with video/audio processing equipment is compatibility with an application programming interface (API) that allows the video/audio processing equipment to apply the effect. An effect plugin that is compatible with video/audio processing equipment may be considered to be a form of package that is consumable by the processing equipment. In some embodiments a plugin may be or include processor-executable code that, when executed by a processor, applies or causes the processor to apply the effect described in the natural language input that is received via the input interface 110. However, other types of effect plugin are also possible. As an example, an effect plugin may be in an intermediate or interim format that can be compiled or otherwise processed for use in processing equipment to apply an effect. Thus, an effect plugin that is compatible with processing equipment for the processing equipment to apply an effect may, but need not necessarily, be or include executable code.

FIG. 3 illustrates an example effect plugin generator 320. As shown in FIG. 3, an effect generator 320 may include a code generator 322, coupled to an input interface, to generate code based on the natural language input received from a user via the input interface. In some embodiments, a compiler 324 may be coupled to the code generator 322, to generate processor-executable code by compiling the code that is generated by the code generator. The compiler 324 is shown in dashed lines and with the label “(Optional)” in FIG. 3, to indicate that a compiler may or may not be provided. For example, as also described at least above, an effect plugin may, but need not necessarily, be or include executable code. The code that is generated by the code generator 322 may be executable code that does not need to be compiled, or may be in an intermediate or interim format that can be compiled or otherwise processed for use in processing equipment. In both of these examples, an effect plugin generator need not include a compiler.

Compiling source code into a binary format, for example, eliminates the need for an interpreter, thereby reducing processing time in real-time applications. An optional compiler 324 as shown in FIG. 3 may thus optimize code by generating executable binaries that reduce processing time, making the effect plugin suitable for realtime or near-realtime applications, for example.

A compiler-based implementation of an effect plugin generator as shown by way of example in FIG. 3 may be particularly beneficial in the context of video/audio processing, to generate code that will run efficiently on a GPU for example, and/or to generate code that will run with sufficient performance to support realtime (or near-realtime) processing of video/audio signals, which might not otherwise be possible without intervention of a skilled programmer. A compiler may be configured or otherwise specially designed to optimize code for execution by a GPU, and/or for high performance execution to support realtime (or near-realtime) processing including a new effect described in natural language input from a user. Code optimization potentially provides shorter implementation time for a described new effect, and may also or instead support live (realtime or near-realtime) video and/or audio production. These are significant technical benefits of effect generation according to embodiments disclosed herein.

Code optimization is not limited only to compiler-based embodiments. More generally, an effect plugin generator may be configured to optimize an effect plugin for realtime or near-realtime application of the effect by processing equipment.

A new effect that is described in a natural language input may have not only an executable code component, but may also (or instead) have a user interface component that provides an effect user interface element. The user interface element may be provided to invoke or otherwise control the effect, for example. A user interface element may also or instead provide an output, such as an indication of progress of video/audio processing. During processing of a video/audio signal to transition from one signal to another, for example, the effect may be or include an effect user interface element that indicates progress of the transition processing.

Thus, some embodiments may involve generating an effect user interface definition for an effect user interface element related to an effect. Such an effect user interface element may be, but need not necessarily be, an element through which the effect is invokable. An effect plugin generator 120, or an effect plugin itself, may be configured to, or otherwise operable to, generate an effect user interface definition. In some embodiments, an effect plugin generator 120 may include a component such as an effect user interface definition generator to generate an effect user interface definition.

An effect user interface element for which an effect user interface definition is generated may be presentable (and presented) in the same user interface (shown as the input interface 110 in FIG. 1) through which the natural language input is received, or in a second user interface (which may also be referred to as an effect user interface) that is different from the user interface through which the natural language input is received. For example, a graphical user interface may include a natural language input element or section for receiving a natural language description of an effect, and the same graphical user interface may include an effect user interface element such as a control element (an icon for example) related to the described effect after the effect plugin has been newly generated. As an example of different interfaces, the natural language input describing a new effect may be received from a user via a microphone, and the effect user interface element related to the new effect may be displayed to and selectable by a user in a graphical user interface.

Similar to executable code for an effect, an effect user interface element for an effect may take any of various forms. As an example, an effect user interface element for a new effect may be implemented in an effect user interface plugin that is compatible with processing equipment. In this example, the effect plugin may be or include an effect user interface plugin. As described at least above for executable code, a plugin is one example. The present disclosure in not in any way limited to generating a plugin to implement a user interface element.

Control features are not limited only to embodiments in which an effect plugin is or includes an effect user interface element plugin. More generally, an effect plugin may provide a control element for controlling the effect.

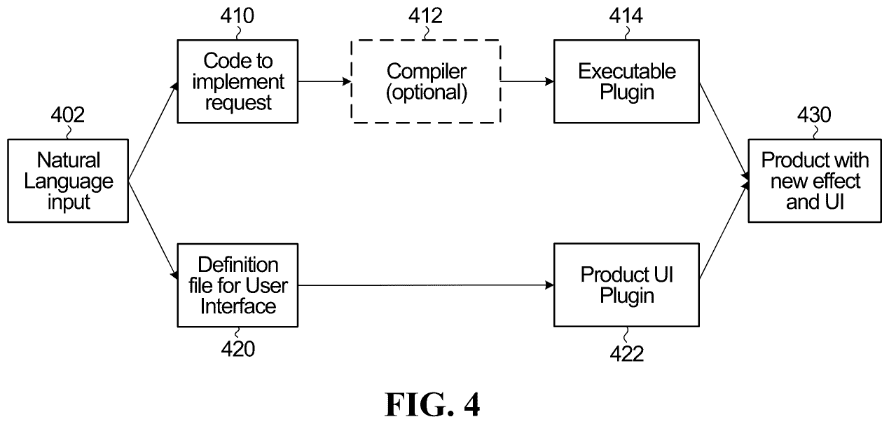

FIGS. 1-3 illustrate examples of processing equipment and components thereof. FIG. 4 illustrates an example process flow.

A natural language input describing an effect is illustrated at 402, and examples of natural language inputs are provided elsewhere herein.

Two process flows are shown in FIG. 4, starting at 410 for executable code and at 420 for a user interface definition. Code to implement a requested new effect described in the natural language input 402 is shown at 410, and an optional compiler is shown at 412. At 414, FIG. 4 illustrates an example of executable code in the form of an executable plugin. A definition file for an effect user interface, including an effect user interface element related to the new effect, is shown at 420, and a product user interface plugin is shown by way of example at 422. The product referenced at 422 is video/audio processing equipment. In some embodiments, a user interface may be built at runtime, including an effect interface element related to the new effect described in the natural language input 402. At 430, FIG. 4 illustrates a product (processing equipment) with a new effect and a new UI.

Consider an example related to creating a transition effect that uses a heart shape. An effect may have one or more parameters, which may include the following for the example transition effect:
1: Percent complete, 0->100;
2: Border size;
3: Border colour (R, G, B);
4: Starting Position (X, Y).

Other parameters may also or instead be specified, or provided for generation of an effect plugin. As an example, an (X, Y) resolution of a display screen on which video resulting from application of the transition effect is to be displayed may also be passed to an effect generator internally in processing equipment, to be taken into account in generating the code for the effect. In this example, (X, Y) is used to indicate form, and not specific values, for starting position and resolution. Starting position values may, and most cases likely will be, different from screen resolution values.

As a user interface definition example, suppose that a live event producer wishes to create a custom video transition effect involving a heart-shaped wipe. A “wipe” is a type of video transition effect used to gradually replace one video clip or scene with another in a visually smooth manner. The wipe in this example uses a heart-shaped pattern as the transition's outline. As the transition progresses, the heart shape “wipes” the first scene away, revealing the second scene underneath. Using a textual input interface, the user may type, “Create a transition effect with a heart shape, a red border, and a 2-second duration” as a natural language input. This input may then be processed to generate an effect plugin that produces the desired effect. The following is an example of a partial user interface definition file (a JavaScript Object Notation (JSON) example) including border information for the example heart-shaped wipe transition effect above.

```
{
  “parameters”: [
    {
      “name”: “Border Width”,
      “type”: “integer″,
      “default”: 10,
      “min”: 1,
      “max”: 100,
      “description”: “Width of the heart-shaped transition border.”
    },
    {
      “name”: “Border Color”,
      “type”: “color”,
      “default”: “255, 0, 0”,
      “description”: “The RGB value of the border color.”
    }
  ]
}
```

With reference to FIG. 4, in this wipe example the input at 402 is a heart transition request, and the output may be a UI plugin at 422, or an executable plugin with integrated UI element at 414.

An effect user interface definition and an effect user interface element related to a new effect may, but need not necessarily, be or include a control element for controlling the new effect. In the heart shape transition effect examples above, the effect user interface element is not a control element.

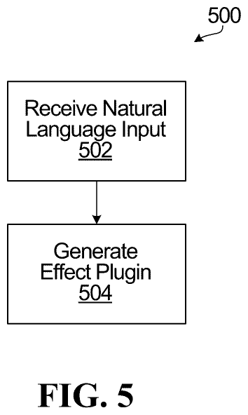

Process flow is considered in FIG. 4 in the context of an example. FIG. 5 is a flow diagram illustrating, more generally, a method according to an embodiment.

The example method 500 involves receiving natural language input at 502 and generating an effect plugin at 504. The receiving at 502 involves receiving, from a user, natural language input describing an effect that is to be applied during processing of a signal by the processing equipment. The effect may be a video effect, an audio effect, or a combined video and audio effect, and the signal may be or include a video signal, an audio signal, or a combined video and audio signal. The generating at 504 involves generating the effect plugin, automatically by an effect generator for example. The effect plugin is compatible with the processing equipment for the processing equipment to apply, during processing of the signal, the effect described by the natural language input.

The natural language input received at 502 may include any one or more of the following:
textual input;
speech input;
graphical input.

The generating at 504 may involve generating processor-executable code that, when executed by a processor of the signal, implements the effect.

In some embodiments, the generating at 504 involves generating code based on the natural language input received from the user, and compiling the code to generate the processor-executable code.

Although not explicitly shown in FIG. 5, a method may involve generating an effect user interface definition for an effect user interface element that is related to the effect. The effect user interface element may be presentable in the input interface, and in some embodiments a method may involve presenting the effect user interface element in the input interface. The effect user interface element may be presentable in a second user interface (which may also be referred to as an effect interface) that is different from the input interface, and in some embodiments a method may involve presenting the effect user interface element in an effect user interface that is different from the input interface.

The effect user interface element may be implemented in an effect user interface plugin that is compatible with the processing equipment.

Code optimization may be implemented in some embodiments, and accordingly a method may involve optimizing the effect plugin for realtime or near-realtime application of the effect by the processing equipment.

Some embodiments may support control of an effect. For example, an effect plugin may provide a control element for controlling the effect.

Other features disclosed herein may also or instead be provided in method embodiments. More generally, features disclosed herein in the context of any embodiment may be provided in other embodiments.

Various embodiments are disclosed herein, primarily in the context of processing equipment and methods. Other embodiments are also possible.

For example, at least functional features may be embodied as computer-executable or processor-executable instructions stored on one or more non-transitory computer-readable or processor-readable storage media. Such instructions, when executed by one or more computers or one or more processors, cause the computer(s)/processor(s) to perform functions or operations disclosed herein, to support features disclosed herein, or to perform a method as disclosed herein.

A non-transitory processor-readable medium according to one embodiment stores instructions which, when executed by a processor, cause the processor to: receive, from a user, natural language input describing an effect that is to be applied during processing of a signal by processing equipment; and generate an effect plugin that is compatible with the processing equipment for the processing equipment to apply the effect during the processing of the signal. The effect plugin is generated based on the natural language input received from the user. As in other embodiments, the effect may be a video effect, an audio effect, or a combined video and audio effect, and the signal may be or include a video signal, an audio signal, or a combined video and audio signal.

What has been described is merely illustrative of the application of principles of embodiments of the invention. Other arrangements and methods can be implemented by those skilled in the art without departing from the scope of the present invention.

For example, the divisions of functions as shown in FIGS. 1-4 are intended solely for illustrative purposes. Embodiments may be implemented with fewer, additional, and/or different components than those explicitly shown. Similarly, a method may include fewer, additional, and/or different operations than those explicitly shown in FIG. 5.

There are also various implementation options for generating an effect plugin, which may involve either or both of generating executable code for applying an effect, or generating an effect user interface definition, for example. One possible option for generating executable code and/or an effect user interface definition based on a natural language description of an effect involves generative AI that is specifically trained on video/audio processing equipment executable code and/or user interface definitions. For example, in some embodiments an effect plugin generator may be or include a generative AI tool. In some method embodiments generating an effect plugin may involve generating the effect plugin by a generative AI tool. As used herein, “generative AI tool” is intended to encompass AI implementations such as generative AI models, networks, devices, systems, or processors, for example, that provide or support generative AI functions.

Effect plugin generation as disclosed herein enables automatic generation of an effect plugin (executable code and/or effect user interface definition) without user intervention or substantive intervention by a skilled programmer or software developer during effect generation.

Video signals, audio signals, and combined video and audio signals are described herein. It should be appreciated that such signals may also include other content, such as data. For example, a video signal, an audio signal, or a combined video and audio signal may include data such as metadata related to the signal. Therefore, an effect may be related to processing of signals that include video and/or audio, and may also include other content such as data.

In addition, although described primarily in the context of equipment, other implementations are also contemplated. Other implementations include, for example, methods, or non-transitory storage media storing executable instructions.

1. An apparatus comprising:
an input interface to receive, from a user, natural language input describing an effect that is to be applied during processing of a signal by processing equipment,
the effect comprising a video effect, an audio effect, or a combined video and audio effect,
the signal comprising a video signal, an audio signal, or a combined video and audio signal;
the apparatus further comprising:
an effect plugin generator, coupled to the input interface, to generate, based on the natural language input received from the user, an effect plugin that is compatible with the processing equipment for the processing equipment to apply the effect during the processing of the signal.

2. The apparatus of claim 1, wherein the input interface provides one or more of the following:
a textual input interface to receive textual input comprising the natural language input;
an audio input interface to receive speech input comprising the natural language input;
a graphical input interface to receive graphical input comprising the natural language input.

3. The apparatus of claim 1, wherein the effect plugin comprises processor-executable code that, when executed by a processor of the processing equipment, applies the effect during the processing of the signal.

4. The apparatus of claim 3, wherein the effect plugin generator comprises:
a code generator, coupled to the user interface, to generate code based on the natural language input received from the user; and
a compiler, coupled to the code generator, to generate the processor-executable code by compiling the code generated by the code generator.

5. The apparatus of claim 1, wherein the effect plugin generator comprises an effect user interface definition generator, coupled to the input interface, to generate an effect user interface definition for an effect user interface element related to the effect.

6. The apparatus of claim 1, wherein the effect plugin generator is further configured to generate an effect user interface definition for an effect user interface element related to the effect.

7. The apparatus of claim 6,
wherein the effect user interface element is presentable in the input interface, or
wherein the effect user interface element is presentable in an effect user interface that is different from the input interface.

8. The apparatus of claim 1, wherein the effect plugin generator is configured to optimize the effect plugin for realtime or near-realtime application of the effect by the processing equipment.

9. The apparatus of claim 1, wherein the effect plugin provides a control element for controlling the effect.

10. The apparatus of claim 1, wherein the effect plugin generator comprises a generative artificial intelligence (AI) tool.

11. The apparatus of claim 1, wherein the effect plugin generator is coupled to the processing equipment.

12. A system comprising:
the apparatus of claim 1; and
the processing equipment, coupled to the effect plugin generator.

13. A method comprising:
receiving, from a user, natural language input describing an effect that is to be applied during processing of a signal by processing equipment,
the effect comprising a video effect, an audio effect, or a combined video and audio effect,
the signal comprising a video signal, an audio signal, or a combined video and audio signal;
the method further comprising:
generating, based on the natural language input received from the user, an effect plugin that is compatible with the processing equipment for the processing equipment to apply the effect during the processing of the signal.

14. The method of claim 13, wherein the natural language input comprises one or more of the following:
textual input;
speech input;
graphical input.

15. The method of claim 13, wherein the generating comprises:
generating processor-executable code that, when executed by a processor of the processing equipment, applies the effect during the processing of the signal.

16. The method of claim 15, wherein the generating comprises:
generating code based on the natural language input received from the user; and
compiling the code to generate the processor-executable code.

17. The method of claim 13, further comprising:
generating an effect user interface definition for an effect user interface element related to the effect.

18. The method of claim 17, further comprising:
presenting the user interface element in the input interface or in an effect user interface that is different from the input interface.

19. The method of claim 17, wherein the effect user interface element is implemented in an effect user interface plugin that is compatible with the processing equipment.

20. The method of claim 13, further comprising:
optimizing the effect plugin for realtime or near-realtime application of the effect by the processing equipment.

21. The method of claim 13, wherein the effect plugin provides a control element for controlling the effect.

22. The method of claim 13, wherein the generating comprises generating by a generative artificial intelligence (AI) tool.

23. A non-transitory processor-readable medium storing instructions which, when executed by a processor, cause the processor to:
receive, from a user, natural language input describing an effect that is to be applied during processing of a signal by processing equipment;
generate, based on the natural language input received from the user, an effect plugin that is compatible with the processing equipment for the processing equipment to apply the effect during the processing of the signal,
the effect comprising a video effect, an audio effect, or a combined video and audio effect,
the signal comprising a video signal, an audio signal, or a combined video and audio signal.

24. A non-transitory processor-readable medium storing instructions which, when executed by a processor, cause the processor to perform the method of claim 13.
